(19) United States
(12) Patent Application Publication
(10) Pub. No.: US 2025/0229314 A1
(43) Pub. Date: Jul. 17, 2025

(54) SYSTEMS AND METHODS FOR SCREENS FOR FIBER PART FORMING MOLDS

(71) Applicant: Congruens Group, LLC, San Carlos, CA (US)

(72) Inventors: Voltaire Lebron, San Carlos, CA (US); Michael John Asbee, San Carlos, CA (US); Joshua Gouled Goldberg, San Carlos, CA (US)

(21) Appl. No.: 18/874,986

(22) PCT Filed: Jun. 13, 2023
(86) PCT No.: PCT/US2023/068343

§ 371 Date: Dec. 13, 2024

Related U.S. Application Data
(60) Provisional application No. 63/358,338, filed on Jul. 5, 2022.
(60) Provisional application No. 63/352,819, filed on Jun. 16, 2022.

(51) Int. Cl. B21D 28/26; D21F 7/00

(52) U.S. Cl. CPC B21D 28/26; D21F 7/00

(57) ABSTRACT

A method of forming a forming mold screen including providing a die plate defining a plate contour and a die center point. A screen is disposed on the die plate. A retainer plate secured to the die plate defines an opening having a retainer center point substantially aligned with the die center point. The screen is disposed between the die plate and the retainer plate and substantially defines a plane. A nested punch unit inserted into the opening includes an inner punch and an outer punch disposed around the inner punch. The inner punch and the outer punch are aligned along an axis substantially aligned with the retainer center point. The screen pressed with the nested punch unit includes pressing the screen with the inner punch followed by pressing the screen with the outer punch.

### CROSS-REFERENCE TO RELATED APPLICATION

This application is being filed on Jun. 13, 2023, as a PCT International application and claims the benefit of and priority to U.S. Patent Application No. 63/352,819, filed on Jun. 16, 2022, and claims the benefit of and priority to U.S. Patent Application No. 63/358,338, filed Jul. 5, 2022, the disclosures of which are hereby incorporated by reference in their entireties.

### INTRODUCTION

Pollution caused by single use plastic containers and packaging materials is now a recognized worldwide problem. Replacing single use packaging with biodegradable and compostable materials is proposed as one way to reduce plastic pollution. However, for a new environmentally-friendly replacement to be successful, it must be competitive in both cost and performance to the incumbent plastic technologies it is to replace.

By way of brief background, molded paper pulp (also referred to as molded fiber) has been used since the 1930s to make containers, trays and other packages. Paper pulp can be produced from recycled materials such as old newsprint and corrugated boxes or directly from tree and other plant fibers. Today, molded pulp packaging is widely used for electronics, household goods, automotive parts, medical products, and food packaging.

Molds are made by machining a metal tool in the shape of a mirror image, if you will, of the finished part. Holes are drilled through the tool and then a screen is attached to its surface. The vacuum is drawn through the holes while the screen prevents the pulp from clogging the holes. Damage to the screen during formation thereof can lead to pulp being drawn into the vacuum holes and adversely affect both the process and finished part.

### SUMMARY

In one aspect, the technology relates a method of forming a forming mold screen, the method including: providing a die plate defining a plate contour and a die center point; disposing a screen on the die plate; securing a retainer plate to the die plate, wherein the retainer plate defines an opening having a retainer center point substantially aligned with the die center point, and wherein the screen is disposed between the die plate and the retainer plate, and wherein the screen substantially defines a plane; inserting a nested punch unit into the opening, wherein the nested punch unit includes an inner punch and an outer punch disposed around the inner punch, and wherein the inner punch and the outer punch are aligned along an axis substantially aligned with the retainer center point; and pressing the screen with the nested punch unit, wherein pressing the screen with the nested punch unit includes pressing the screen with the inner punch followed by pressing the screen with the outer punch. In an example, the nested punch unit includes at least one intermediate punch disposed between the inner punch and the outer punch, and wherein pressing the screen with the nested punch unit includes pressing the screen with the at least one intermediate punch after pressing the screen with the inner punch and before pressing the screen with the outer punch. In another example, pressing the screen with the nested punch unit includes moving the inner punch towards the plate contour while substantially maintaining a position of the outer punch relative to the plate contour. In yet another example, pressing the screen with the nested punch unit includes deforming an inner portion of the screen with the inner punch. In still another example, pressing the screen with the nested punch unit includes maintaining a pressure against the screen with the inner punch while deforming the screen with the outer punch.

In another example of the above aspect, pressing the screen with the nested punch unit includes bottoming the inner punch against the screen and the die plate prior to pressing the screen with the outer punch. In an example, bottoming the inner punch substantially prevents further deformation of the screen by the inner punch. In another example, the nested punch unit includes a pressing contour substantially similar to the plate contour. In yet another example, pressing the screen with the nested punch unit includes bottoming the outer punch against the screen and die plate. In still another example, the method further includes removing the screen from between the retainer plate and the die plate; and trimming the screen.

In another aspect, the technology relates to a method of deforming a substantially flat screen, the method including: disposing the substantially flat screen between a die plate including a contour and a retainer plate defining an opening having a retainer center point substantially aligned with a center point of the contour; and sequentially deforming the screen with a plurality of punches, wherein the plurality of punches are substantially centered along an axis aligned with the center point of the contour, and wherein the plurality of punches includes an inner punch and an outer punch and wherein the inner punch deforms the screen first and wherein the outer punch deforms the screen last. In an example, the method further includes, during the deformation of the screen by the outer punch, applying a pressure with the inner punch against the screen. In another example, the pressure applied against the screen by the inner punch is applied at least in part by a first spring. In yet another example, the first spring biases the inner punch away from the outer punch. In still another example, the plurality of punches further includes an intermediate punch between the inner punch and the outer punch, and wherein the intermediate punch deforms the screen after the inner punch and before the outer punch.

In another example of the above aspect, the method further includes, during the deformation of the screen by the outer punch, applying pressure with the intermediate punch against the screen. In an example, the pressure applied against the screen by the intermediate punch is applied at least in part by a second spring. In another example, the second spring biases the intermediate punch away from the outer punch.

In another aspect, the technology relates to a system for deforming a screen, the system including: a die plate defining a contour and a die center point; a retainer plate defining an opening having a retainer center point substantially aligned with the die center point; and a nested punch unit including an inner punch, an outer punch disposed around the inner punch, and a first spring biasing the inner punch away from the outer punch, wherein the inner punch and the outer punch are aligned along an axis substantially aligned with the retainer center point, wherein the nested punch unit includes a deformation surface substantially mirrored to the contour. In an example, the inner punch is at least partially slidably engaged with the outer punch. In another example, the nested punch unit further includes: at least one intermediate punch disposed between the inner punch and the outer punch; and a second spring biasing the intermediate punch away from the outer punch, and wherein the first spring biases the inner punch away from the intermediate punch. In yet another example, the inner punch is at least partially slidably received with the intermediate punch and the intermediate punch is at least partially slidably received in the outer punch.

### BRIEF DESCRIPTION OF DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of a particular example. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure.

FIGS. 1A and 1B depict a perspective view and a partial enlarged perspective view, respectively, of a forming mold of a molded fiber part manufacturing system.

FIGS. 2A and 2B depict an exploded perspective view and an exploded sectional perspective view, respectively, of a system for deforming a screen.

FIG. 2C depicts a sectional view of a nested punch unit.

FIGS. 3A-3H depicts an example system for deforming a screen, and a method of deforming a screen.

FIGS. 4A-4E depicts another example system for deforming a screen, and a method of deforming a screen.

FIG. 5 depicts a method of forming a forming mold screen.

FIG. 6 depicts another method of forming a forming mold screen.

FIG. 6A depicts optional operations related to the method of FIG. 6.

### DETAILED DESCRIPTION

Before the production lines for producing molded fiber products are disclosed and described, it is to be understood that this disclosure is not limited to the particular structures, process steps, or materials disclosed herein, but is extended to equivalents thereof as would be recognized by those ordinarily skilled in the relevant arts. It must be noted that, as used in this specification, the singular forms “a,” “an,” and “the” include plural referents unless the context clearly dictates otherwise. Thus, for example, reference to a “step” or “operation” may include multiple steps or operations, and reference to “producing” or “products” of a step or operation should not be taken to be all of the products.

Various embodiments of the technology described below relate to the manufacture of fiber-based or pulp-based products for use both within and outside of the food and beverage industry. The fiber-based products are adapted to replace their plastic counterparts in a wide variety of applications such as, for example: frozen, refrigerated, and non-refrigerated foods; medical, pharmaceutical, and biological applications; microwavable food containers; beverages; comestible and non-comestible liquids; substances which liberate water, oil, and/or water vapor during storage, shipment, and preparation (e.g., cooking); horticultural applications including consumable and landscaping/gardening plants, flowers, herbs, shrubs, and trees; single-use or disposable storage and dispensing apparatuses (e.g., paint trays, food trays, brush handles, protective covers for shipping); produce (including human and animal foodstuffs such as fruits and vegetables); salads; prepared foods; packaging for meat, poultry, and fish; lids; cups; bottles; guides and separators for processing and displaying the foregoing; edge and corner pieces for packing, storing, and shipping electronics, mirrors, fine art, and other fragile components; buckets; tubes; industrial, automotive, marine, aerospace and military components such as gaskets, spacers, seals, cushions, and the like; and associated molds, wire mesh forms, recipes, processes, chemical formulae, tooling, slurry distribution, chemical monitoring, chemical infusion, and related systems, apparatus, methods, and techniques for manufacturing the foregoing components.

An existing production line for manufacturing molded fiber parts or products is described in Chinese Patent Application No. 201711129438.X (hereinafter, “the '438 application”), entitled “Flexible Production Line for Producing Pulp Molded Products,” which is hereby incorporated by reference herein in its entirety. The '438 application describes generally a forming station that includes a forming mold having a screen disposed thereon. The forming mold creates a wet part by dipping a first mold into a tank of fiber slurry, drawing fiber via vacuum channels in the mold until a desired amount of fiber is collected on the screen, and then removing the mold with the attached fiber layer from the slurry. In the system described in the '438 application, the forming station also subjects the wet part to a forming operation in which the first mold with the attached layer of fiber is pressed into a second mold after it is removed from the slurry. This forming operation removes some water from the wet part and contours the surface of the wet part opposite the first mold. In the production line of the '438 application, after the molded fiber part is created by the forming station, it is then pressed in a pressing station. The pressing station may be a plurality of pressing stations, operating in parallel. In one example of the '438 application, four pressing stations are utilized. Each of the four pressing stations in the '438 application includes a single press. Parts are sent to a stacking station after pressing. The forming station, pressing stations, and stacking station are arranged in a circle around a centrally located robot controlling an extendable robotic arm. The robot and robotic arm are configured to remove formed parts from the forming station and transfer them to any one of the four pressing stations. The robotic arm is further configured to remove pressed parts from any the pressing stations and transfer them to either a different one of the pressing stations or to the stacking station. Although the application depicts a number of basic components and stations of a molded fiber part manufacturing line, it unfortunately displays a number of inefficiencies.

The present application is directed to new methods for manufacturing the screen that is used in conjunction with a forming mold on the forming station. In examples, flat sheets of woven wire screen are progressively formed, in stages, with a set of punches and dies. Forming in multiple stages, as opposed to in a single stage, allows the forming to progress from the center portion of the screen, out towards the perimeter. This center-out approach helps prevent wrinkles and minimizes the distortion of the openings between the mesh, as the screen is allowed to gradually take shape. To achieve this, a set of concentric punches or presses are sequentially advanced into a die system. Once an inner portion of the screen is deformed, pressure is maintained in that portion with the press while an outer portion is deformed, thus securing previously-deformed portions of the screen while other portions are presently-deformed. This action of restricting movement of the inner, deformed portions of the screen, while pressing outer portions of the screen, allows the outer edges of the screen to be drawn inward, as further outer portions of the screen are pressed and deformed, preventing stretching of the mesh, which can lead to poor performance when mounted on a forming mold. To begin, a screen is placed over the die opening, then secured with a hold-down plate and a series of screws, bolts, or other fasteners. In other example, the weight of the hold-down plate may be sufficient to hold the screen in place. The screen is not held tightly between the die plate and the hold-down plate; rather, the screen is held loosely such that deformation of the screen will draw the edges of the screen inward towards the center. The punches are nested and then pressed into the screen using a press (e.g., hydraulic, pneumatic, electric), starting with an innermost punch and working progressively outward. The resulting screen is one with few to no wrinkles, pleats, or excessive distortion of the weave. Screens manufactured with this method can be trimmed along the outer edge, or left flat to be secured with a ring more typical of forming molds.

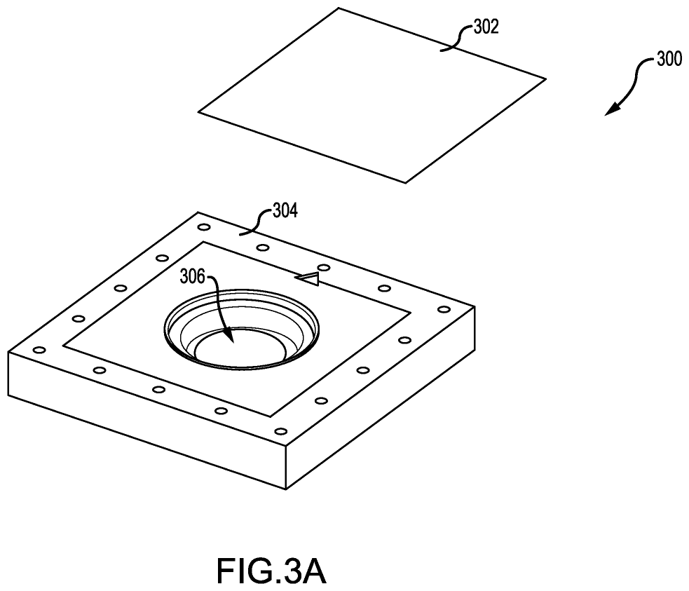

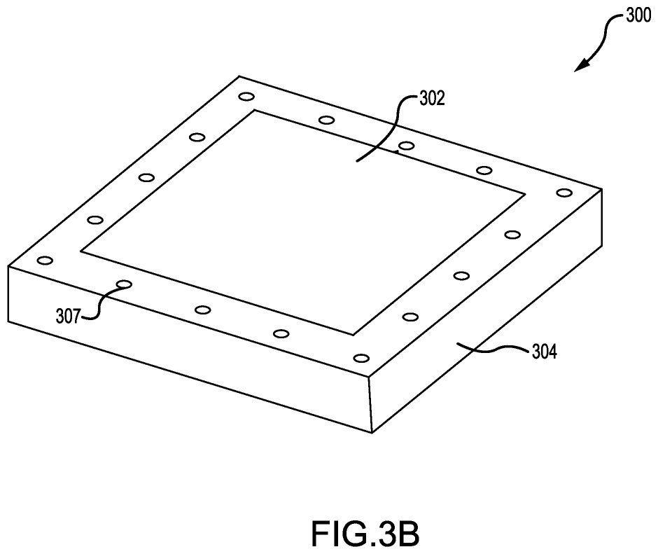

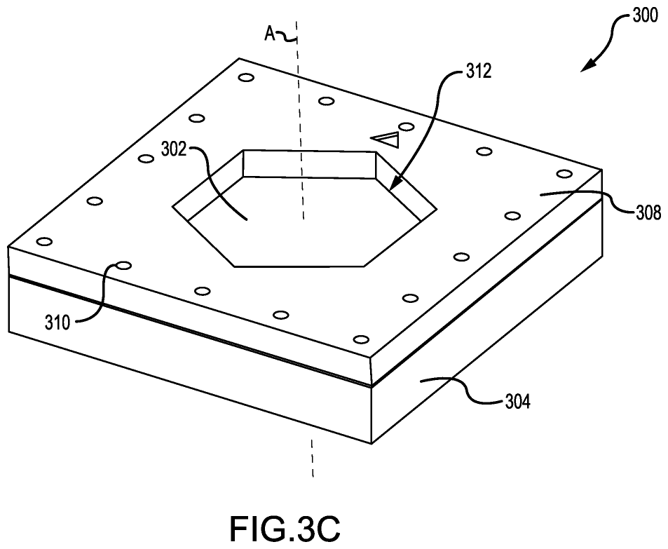

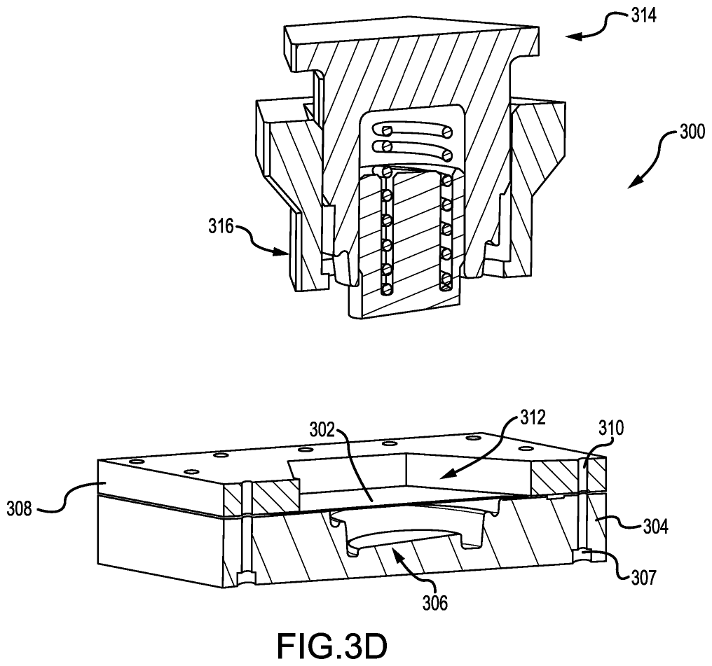

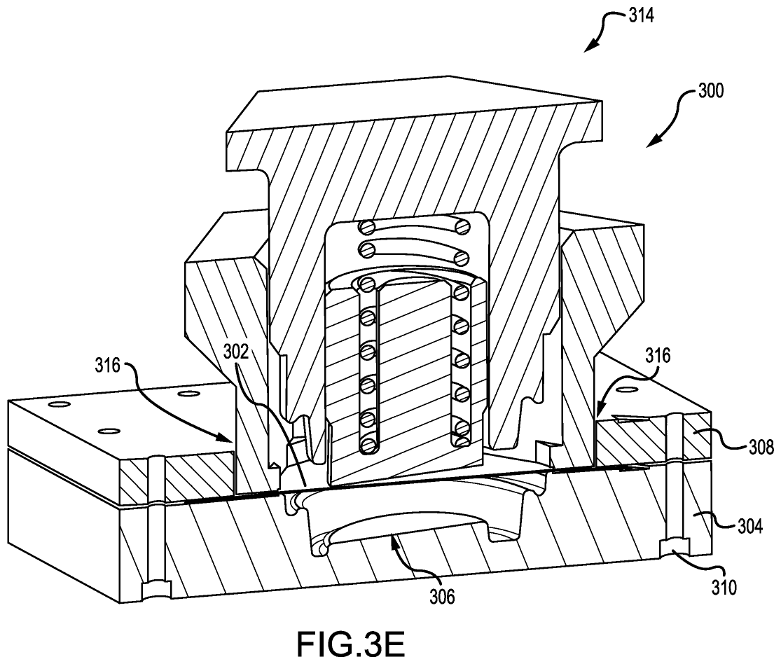

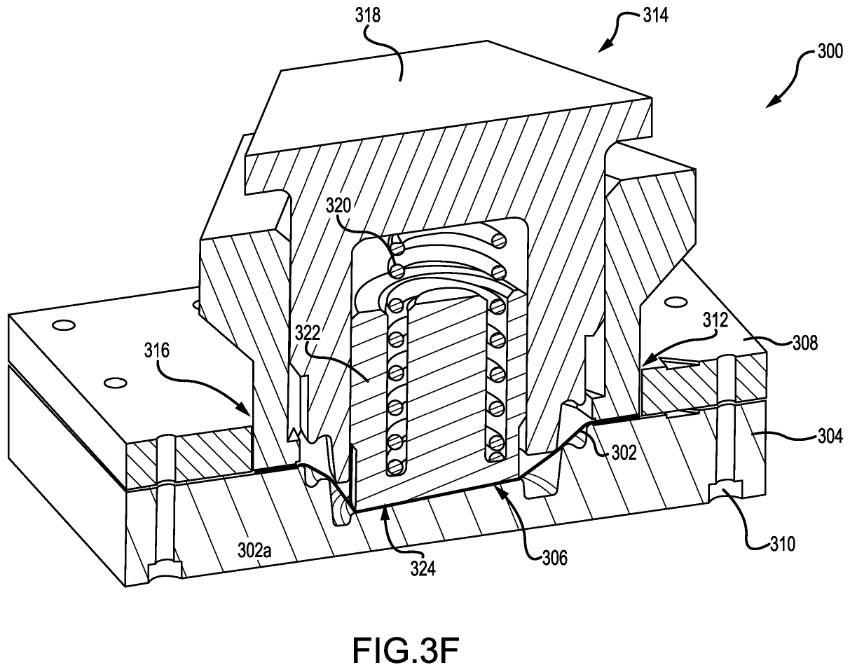

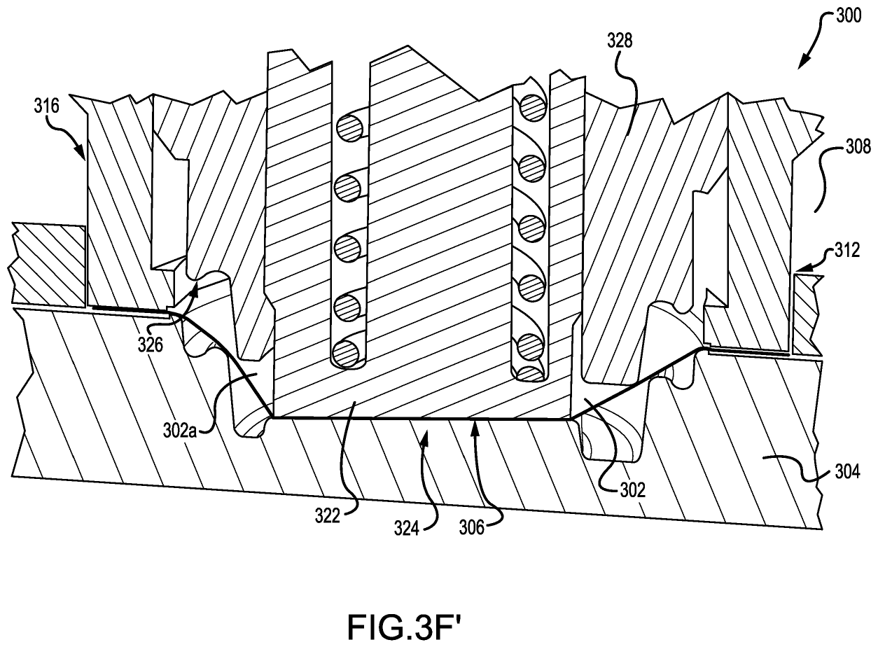

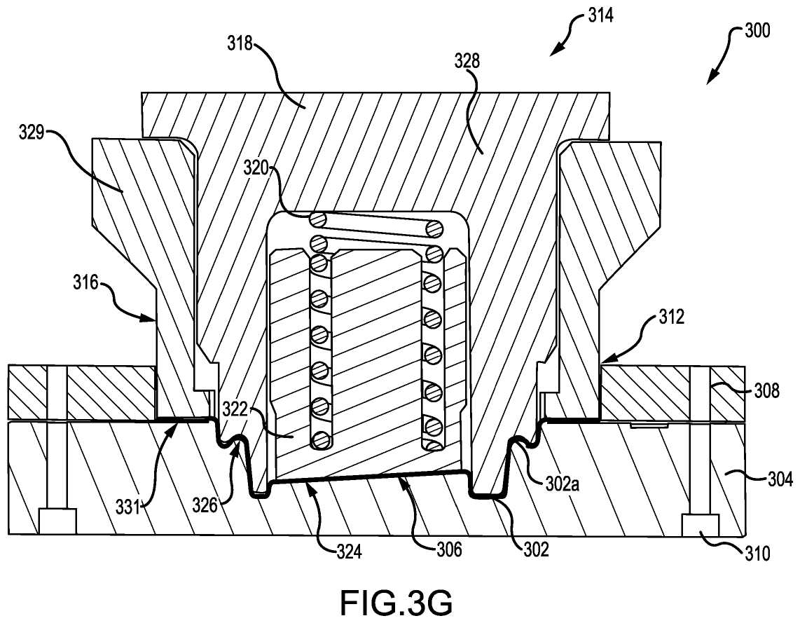

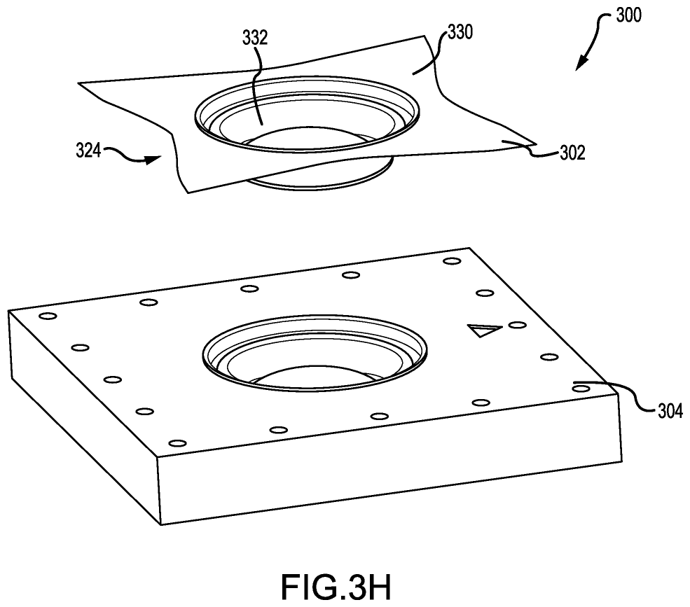

In another example, the press applies pressure to multiple punches sequentially. For example, as depicted in FIG. 3E, a stiff spring is incorporated to apply pressure to the innermost punch as the press applies force to a plunger directly driving an intermediate punch. As the inner punch reaches full depth, the spring compresses as the intermediate punch is forced downward by continued application of pressure against the plunger. Just before reaching full depth, the outer punch catches on the plunger, to deform the screen along the perimeter. In this method, wrinkles and pleats are reduced or eliminated and the mesh openings do not close up. Some mild waviness of the screen may be present along areas of the perimeter of the screen, but that is outside the area intended for forming.

In examples, screens are formed using a 40-mesh and a 60-mesh material by the method described above, then placed one on top of the other and mounted in a forming mold tooling set specifically designed for these screens. The tooling consists of a porous mold body to support the screens while facilitating vacuum flow. The screens are placed on top of this body, first the 40 mesh then the 60 mesh as the outermost layer. The tool was then lowered into a fiber slurry at a forming mold station and slurry gathered. The parts formed without any significant issues, such as thin spots or tearing, and released cleanly from the mold. Additionally, the reproduction of shape is on par with that of traditionally manufactured screens.

In another example, the nested punch unit was increased from three to four punches. The number of punches is largely driven by the number of ridge features in a part. In an example coffee cup lid, four stages may be required, but a clamshell container may require fewer. The outer rim of the mold is dished-out, to help gather more slurry. When combined with the rest of the tooling, this will create a gripping skirt geometry that holds the part to a mating container. Sharp corners were also softened.

In an example nested punch unit, a set of three springs is designed into the punch stack, roughly doubling in spring weight at each stage. Again, as the downward force is applied (provided by a press) the springs transfer that force to the screen. As forming progresses, the various punches bottom out and maintain pressure as subsequent punches compress the springs. The resulting screens are smoother, with virtually no wrinkles along the perimeter, no signs of tearing, and even required less force to form (an indication of lower stresses imparted to the screen). The screen was again mounted into a quick-change mold and lowered into a molded fiber slurry. This configuration gathers more slurry along the skirt in order to better form the gripping skirt feature at the hot press.

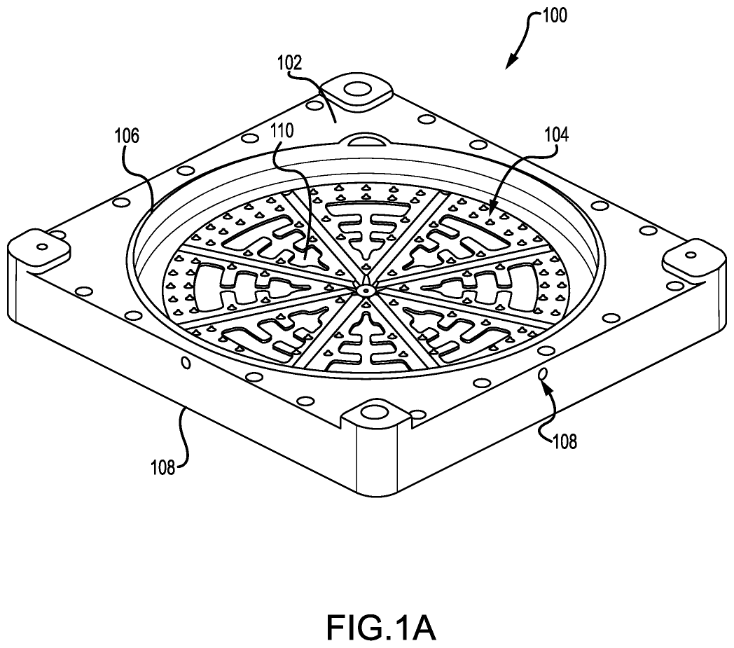

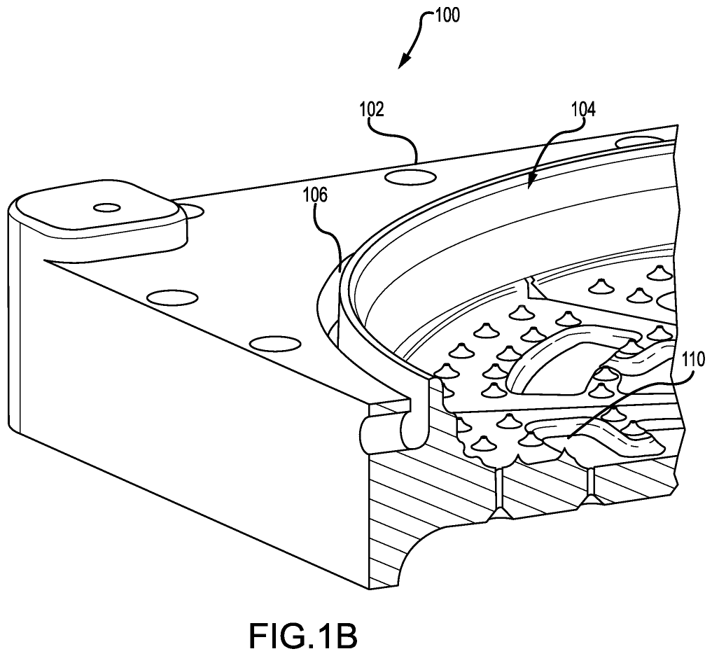

FIGS. 1A and 1B depict a perspective view and a partial enlarged perspective view, respectively, of mold 100 for a forming station. FIGS. 1A and 1B are described concurrently. The forming mold 100 is formed from a machined unitary part 102. The unitary part 102 has formed therein a cavity mold 104 that, in the depicted example, includes an integral trimmer 106 that defines an outermost extent of a molded fiber product (not shown) formed with the mold 100. As described above, one or more vacuum channels formed in the part 102 may be communicatively coupled to ports 110 on the surface of the cavity 104 to draw liquid, under vacuum, from the partially-formed fiber part during pressing operations. The mold 100 of FIGS. 1A and 1B is depicted to illustrate the complex mold shapes that may be formed in the manufacturing lines such as depicted in the '438 application. A screen must also be formed to cover the mold 100, and is generally substantially similar in contour to the mold 100 itself. During the forming process, the pulp slurry is drawn by vacuum onto the screen for initial forming of the molded part. Complex molds can require equally complex screens, and forming any screen (especially complex ones) requires significant deformations to an otherwise flat screen in order for the screen to obtain a final form factor appropriate for use. Deformations of any sort (and particularly complex deformations, or deformations required to make a particularly tall molded fiber part) can damage the screen, lead to larger than acceptable gaps between screen filaments, or cause folds, creases, or other formations that lead to molded fiber products with inferior appearance and that may be subject to failure points.

As such, the technologies described herein use multi-stage or nested press units to form a screen in multiple stages. A nested press unit consisting of a plurality of discretely-actuated presses is used to form a screen in sections, as opposed to in a single pressing operation. In examples, the finished screen is formed by deforming the innermost section thereof first with a first (innermost) portion of the press unit. Thereafter, a second section of the screen disposed outside of the first section is deformed with a second (intermediate) portion of the press unit, which is located adjacent and around the first portion. Thereafter, a third section of the screen disposed outside of the second section is deformed with a third portion (also referred to as intermediate) of the press unit, which is located adjacent and around the second portion. This multi-stage deformation operation is continued until an outermost press of the nested press unit, located adjacent and around the last intermediate portion of the press unit, deforms the outermost section of the screen. During each discrete deformation, pressure is maintained on portions of the screen already deformed by a respective press portion of the nested press unit. This helps ensure that screen material is drawn inward from the free outer edges of the screen, as opposed to stretching more centrally-located portions of the screen.

Nested press units may be formed of any number of discretely-actuated presses. In examples, each discrete press may be actuated by applying pressure to only that discrete press. In other examples, each press may be biased away from an adjacent press by a spring or other biasing member. Each spring may have a spring force that is calculated to compress based on the resistance offered at various stages of screen deformation. In other words, in a nested press unit that includes a spring between the two discrete presses, the spring may resist deformation as the central press of the nested press unit deforms the screen (that is, the spring force of the spring is greater than the spring force inherent in the screen material resisting deformation. Once that central portion of the screen is fully deformed, the spring force of the spring is calculated to be less than the spring force inherent in the remaining screen material revisiting deformation. These spring coefficients may be calculated as required for any number of discrete presses within a nested press unit.

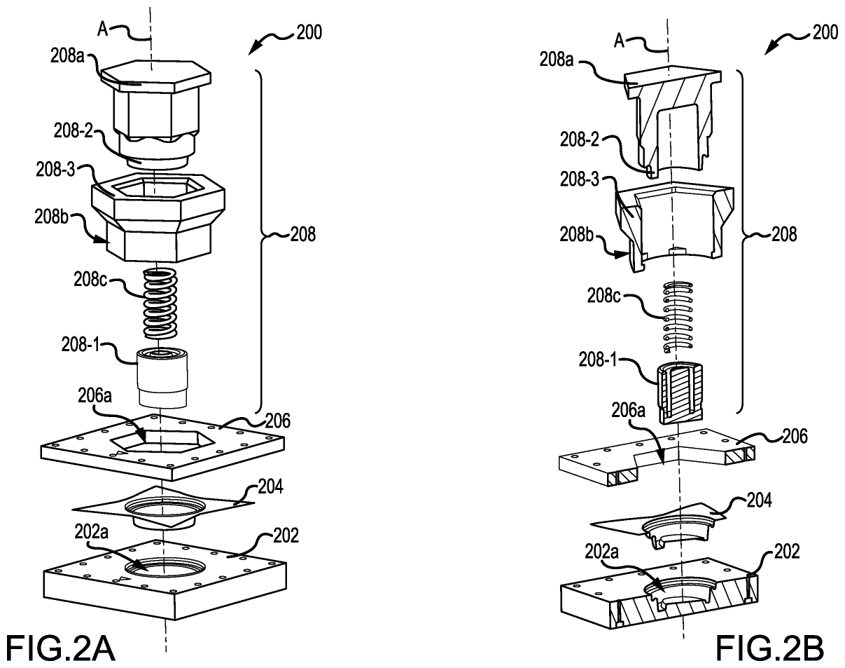

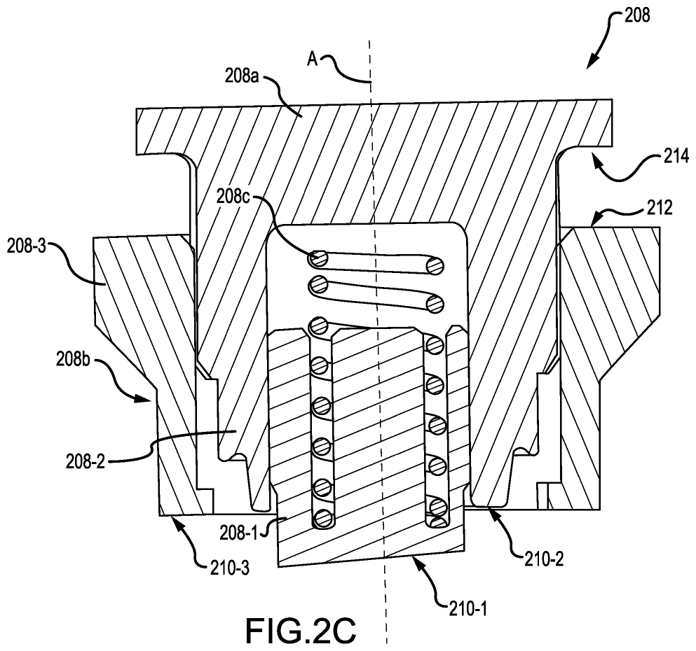

FIGS. 2A and 2B depict an exploded perspective view and an exploded sectional perspective view, respectively, of a system 200 for deforming a screen. FIG. 2C depicts a sectional view of a nested punch unit 208, which forms a part of the system 200. FIGS. 2A and 2B are described concurrently, along with FIG. 2C. The system 200 includes a die plate 202 that includes a contour surface 202a and a center point disposed along an axis A. A finished screen 204 is depicted in FIGS. 2A and 2B for illustrative purposes between the die plate 202 and a retainer plate 206, which defines an opening 206a and a retainer center point also disposed along axis A. The nested punch unit 208 is configured to be received in the opening 206a. The nested punch unit 208 includes a center or inner punch 208-1, an intermediate punch 208-2, an outer punch 208-3. The outer punch 208-3 also includes a guide 208b that interfaces with the opening 206a. The outer punch 208-3 also allows relative sliding movement of the punches 208-1 and 208-2. A plunger 208a presses both the center punch 208-1 and the intermediate punch 208-2 (with which the plunger 208a is integrally formed), as described herein. A spring 208c disposed between the inner punch 208-1 and the intermediate punch 208-2 controls, in part, actuation of the nested punch unit 208, as described herein.

In examples, when the plunger 208a is pressed, the spring force of the spring 208c is stronger than the spring force inherent in the screen 204, which allows the screen 204 to be deformed downward and between the inner punch 208-1 and the contour surface 202a of the die plate 202. As described in more detail herein, pressing the plunger 208a advances the spring 208c and inner punch 208-1 together within the guide 208b until the inner punch 208-1 bottoms out (e.g., reaches the end of its range of motion), such that the screen 204 is pressed tightly between the contour surface 202a of the die plate 202 and the inner punch 208-1. At this stage, further downward motion of the plunger 208a advances the intermediate punch 208-2 as the spring 208c is compressed between the inner punch 208-1 and the intermediate punch 208-2. Thus, the intermediate punch 208-2 deforms an outer portion of the screen 204, while the spring 208c also maintains a compressive force against the inner punch 208-1 and that portion of the screen 204. The plunger 208a and intermediate punch 208-2 may advance while deforming a portion of the screen 204 disposed below, until the intermediate punch 208-2 bottoms out. Further deformation function of the nested press unit is described in the context of FIG. 2C.

FIG. 2C depicts a sectional view of a nested punch unit 208, e.g., as depicted in FIGS. 2A and 2B. Each of the inner punch 208-1, intermediate punch 208-2, and outer punch 208-3 comprise a pressing contour 210-1, 210-2, 210-3 respectively. Each pressing contour 210-1, 201-2, 210-3 may be substantially similar to an associated portion of the contour surface 202a of the die plate 202, e.g., in a mirror image configuration of the of the contour surface 202a (as depicted in FIGS. 2A and 2B). As can be seen in FIG. 2C, and as described above, a downward pressing of the plunger 208a advances the inner punch 208-1 along with the spring 208c and the intermediate punch 208-2, which is integral with the plunger 208a. Once the inner punch 208-1 bottoms out, further downward motion of the plunger 208a compresses the spring 208b to maintain pressure against the portion of the screen deformed by the inner punch 208-1, while the pressing contour 210-2 of the intermediate punch 208-2 deforms the screen. Continued pressing of the plunger 208a causes contact between a shoulder 212 of the outer punch 208-3 and a flange 214 of the plunger 208a to advance the outer punch 208-3. In this example configuration, the outer punch 208-3 performs a crimping function. Once the punches 208-1, 208-2, 208-3 have bottomed out, deformation is terminated and the finished screen may be removed for further processes such as trimming.

FIGS. 3A-3H depicts an example system 300 for deforming a screen 302, and a method of deforming a screen 302. The figures are described concurrently and not all features are necessarily depicted or labeled in all figures. The system 300 includes a die plate 304 that includes a contour surface 306 and a plurality of mating receivers 307 around a perimeter thereof. The contour surface 306 approximates both the mold onto which the finished, deformed screen will be installed, as well as the shape of the finished molded fiber part. The screen 302 is placed on the die plate 304, as depicted in FIG. 3B, so as to cover the contour surface 306 of the die plate 304. In this position, the screen 302 effectively defines a flat reference plane above the contour surface 306. In FIG. 3C, a retainer plate 308 is disposed on top of the screen 302. The retainer plate 308 may be secured to the die plate 304 via a plurality of mechanical fasteners (e.g., bolts or screws, not shown), inserted into a plurality of fastener openings 310, so as to extend into the mating receivers 307 in the die plate 304. The retainer plate 308 defines an opening 312 that may include a center point that is disposed along an axis A that is centered on the contour surface 306.

In FIG. 3D, a nested punch unit 314 is provided. In this example, the nested punch unit 314 is structurally similar to that depicted in FIGS. 2A-2C. As such, not every component thereof is described further. A guide 316 of the nested punch unit 314 is inserted into the opening 312 and rests at least lightly on the screen 302, while being supported by the die plate 304, as depicted in FIG. 3E. In this figure, the screen 302 remains in its initial planar configuration, prior to being subjected to any deformation. A first stage of a pressing operation is depicted in FIG. 3F, where a plunger 318 of the nested punch unit 314 is depicted pressed towards the die plate 304. A spring 320 provides a greater spring force that that inherent in the screen 302 during deformation, thus keeping an inner punch 322 pressing downward as the plunger 318 is depressed. This deforms the screen 302 between the die plate contour 306 and the pressing contour 324 of the inner punch 322; deformation of the screen between the inner punch 322 and the die plate contour 306 is complete once the inner punch 322 bottoms out. FIG. 3F also depicts a portion 302a of the screen 302, not below the inner punch 322 that is deflected downwards into the die plate 304, but is not yet contoured, as it has not yet been deformed by any corresponding portion punch or contour. Thus, this portion 302a corresponds generally to a portion of the screen that is drawn inward from an outer edge thereof, as the inner portion of the screen 302 is pressed and contoured. FIG. 3F′ is an enlarged partial view of the system of FIG. 3F and depicts more clearly the complex die plate contour 306 and corresponding pressing contour 324 of the inner punch 322. FIG. 3F′ also depicts the pressing contour 326 of an intermediate punch 328, and the portion 302a of the screen 302 that is drawn down into the die plate 304, prior to actual pressing and contouring of that portion 302a.

FIG. 3G depicts the completion of the second stage of screen 302 deformation, wherein the intermediate punch 328 has bottomed out at the contour 306 of the die plate 304. In this condition, the spring 320 is also fully compressed, so as to press and contour the portion 302a of the screen 302 that had been drawn downward into the die plate 304 as the inner punch 322 was pressing the screen 302. FIG. 3G also depicts the condition where the plunger 318 contacts an outer punch 329, so as to force an outer pressing contour 331 into the screen 302 to crimp the screen 302. In FIG. 3H, the nested punch unit and retainer plate have been removed from the system 300. The deformed screen 302 is removed from the die plate and may have a perimeter portion 330 that may be trimmed or otherwise removed from around the finished deformed screen 332. As can be seen, since the edges of the screen 302 are not held tightly between the retainer plate 308 and the die plate 304, the finished deformed screen 332 includes drawn-in edges 334, where the screen 302 is drawn inward without undesirable stretching of the mesh, during the deformation process. The finished deformed screen 322 may then be attached to the related mold for formation of molded fiber parts.

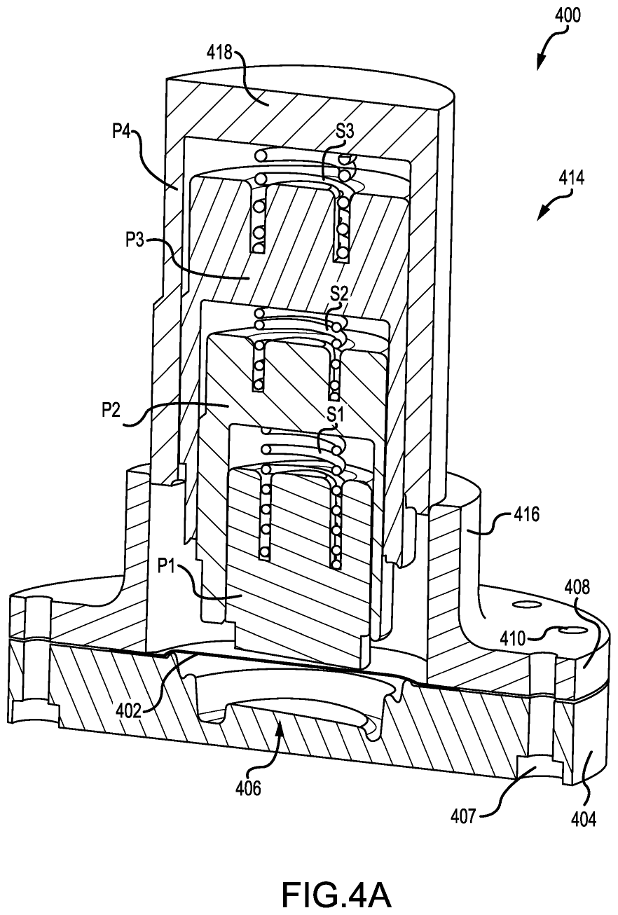

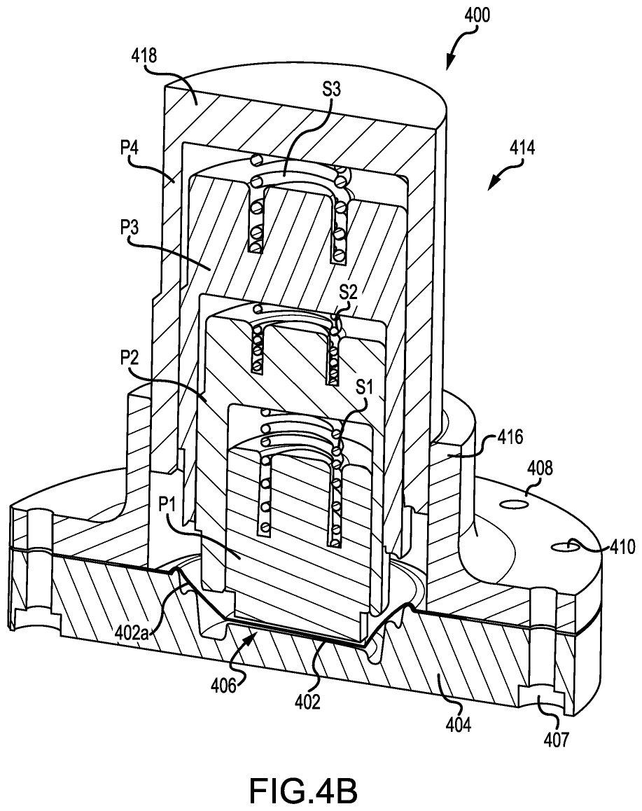

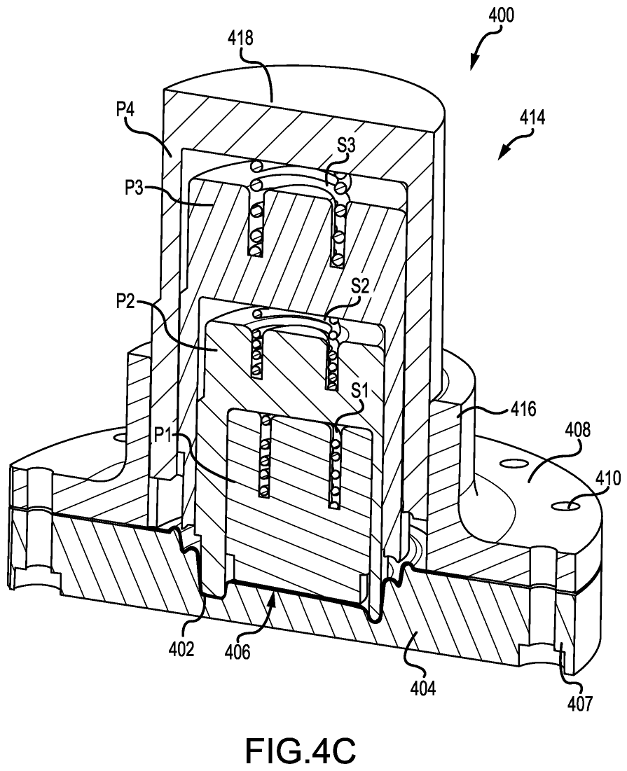

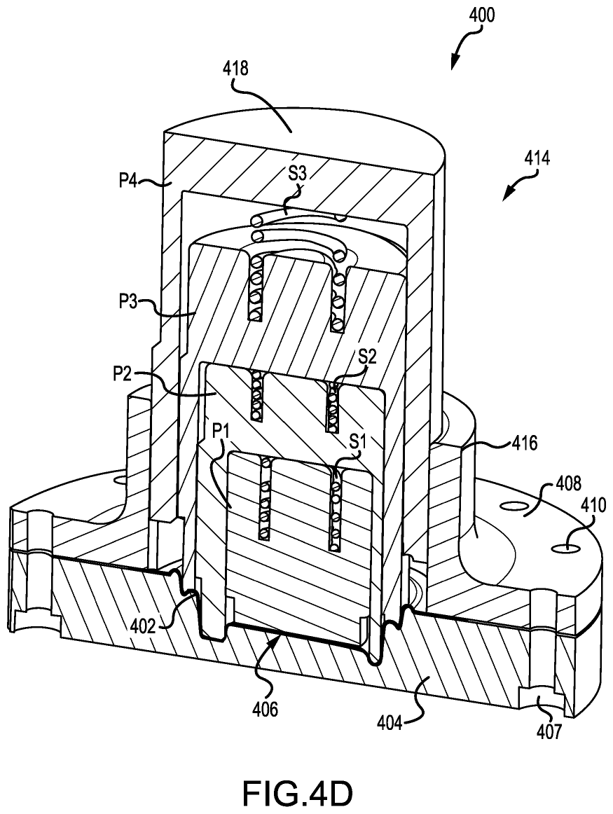

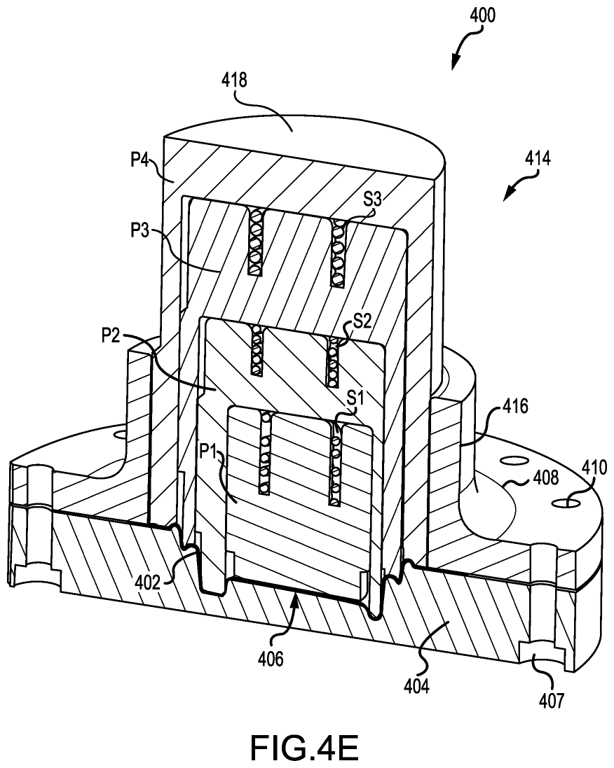

FIGS. 4A-4E depicts another example system 400 for deforming a screen 402, and a method of deforming a screen. As with the example of FIGS. 3A-3H, the system 400 includes a die plate 400 having a die plate contour 406. A retainer plate 408 is secured to the die plate 404 via fasteners inserted through openings 407, 410, and includes a guide 416 integral therewith. A nested punch unit 414 includes an inner punch P1, a second (intermediate) punch P2, a third (intermediate) punch P3, and an outer punch P4, which is integral with a plunger 418. Each of the punches P1-P4 are biased away from an adjacent punch by a spring S1, S2, S3. When depressing the plunger 418, the spring force of each spring S1, S2, S3 is such that forces bias the adjacent punches P1, P2, P3, P4 away from each other until a punch associated with a particular spring S1, S2, S3 (respectively) bottoms out at the contour 406 of the die plate 404. For example, in FIG. 4A, prior to depressing the plunger 418, all of the springs S1, S2, S3 bias the punches P1, P2, P3 away from punch P4. In FIG. 4B, punch P1 has nearly bottomed out, performing a first stage of deformation of the screen 402, but the spring S1 has not yet compressed. This causes the drawing in of a portion 302a of the screen 302 that is adjacent the screen 302 that is disposed between the punch P1 and the die plate 304.

In FIG. 4C, the punch P1 has bottomed out. Further downward force on the plunger 418 compresses spring S1 as punch P2 moves downward, until spring S1 is fully compressed and punch P2 bottoms out. Further downward force on plunger 418 compresses spring S2, as punch P3 moves downward. In FIG. 4D, the punch P3 has bottomed out, thereby compressing spring S2 completely. Further downward force on plunger 418 compresses spring S3, as punch P4 moves downward. In FIG. 4E, the punch P4 has bottomed out, thereby compressing spring S3 completely. As each punch P1, P2, P3, P4 sequentially deforms its associated portion of screen 402, previously bottomed-out punches P1, P2, P3, P4 maintain pressure on those deformed portions of the screen 402, thus preventing deformed portions from being drawn outwards from the center of the screen 402. Instead, outer portions of the screen 302 are further drawn inward, until the entire compressive operation is finished.

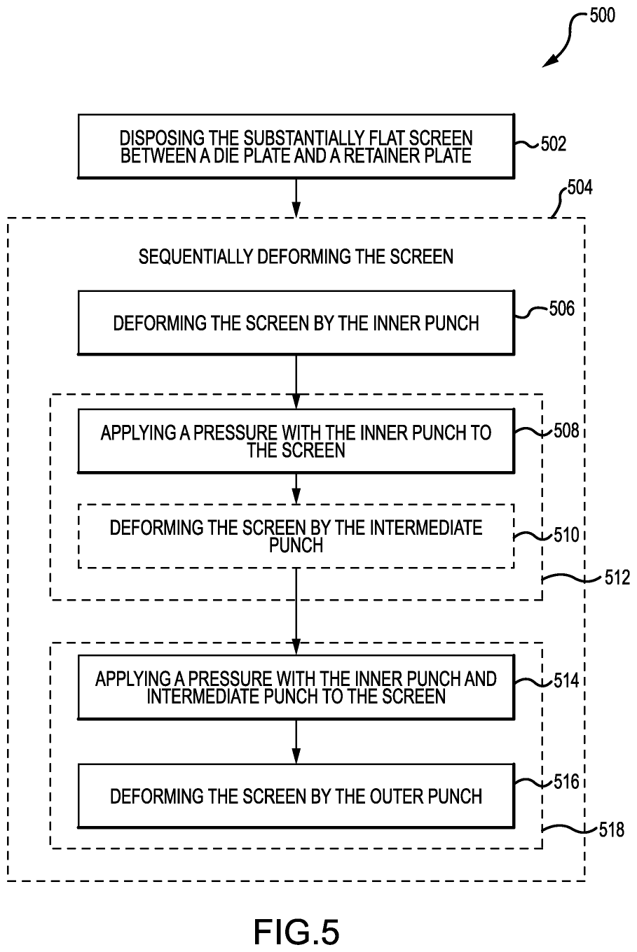

FIG. 5 depicts a method 500 of forming a forming mold screen. The method 500 begins with operation 502, disposing the substantially flat screen between a die plate and a retainer plate. Examples of such die and retainer plates are described herein. In general, however, the die plate would include a contour, while the retainer plate would define an opening having a retainer center point substantially aligned with a center point of the contour. In operation 504, sequential deformation of the screen is performed, with a plurality of punches. In an example, sequential deformation includes sequentially deforming the screen with the plurality of punches that are substantially centered along an axis aligned with the center point of the contour. Operation 504 includes a number of sub-operations, depending on the number of punches, as depicted in FIG. 5. In an example, the plurality of punches include an inner punch and an outer punch that are sequentially actuated such that the inner punch deforms the screen first, operation 506. Depending on the configuration of the deformation system, the pressure applied against the screen by the inner punch is applied at least in part by a first spring, which may bias the inner punch away from an adjacent punch (either an outer punch, or an intermediate punch, if utilized).

The method 500 of FIG. 5 contemplates use of an optional, intermediate punch in forming the screen. Whether one or more intermediate punches are utilized, or whether an outer punch is utilized, operation 508, applying a pressure with the inner punch against the screen, is performed when any adjacent punch is used to deform the screen. In operation 510, deforming the screen by the intermediate punch is performed. The pressure applied against the screen by the intermediate punch may be applied at least in part by a second spring, which may bias the intermediate punch away from an adjacent punch, such as an outer punch. Dashed box 512 illustrates that operations 508 and 510 are performed simultaneously. As noted above, this prevents already-deformed screen mesh material from being drawn outward as an outer portion of a screen is pressed and deformed. Pressure is applied to the screen by both the inner punch and intermediate punch, operation 514, once the screen is fully deformed by the intermediate punch. Deformation of the screen is then performed by the outer punch, operation 516, which is performed substantially simultaneously (as per box 518) with operation 514. Thus, in the method of FIG. 5, the outer punch deforms the screen last, after previous sequential deformation by first the inner punch, then the intermediate punch. Any number of intermediate punches may be included to deform the screen sequentially, as required or desired for a particular application.

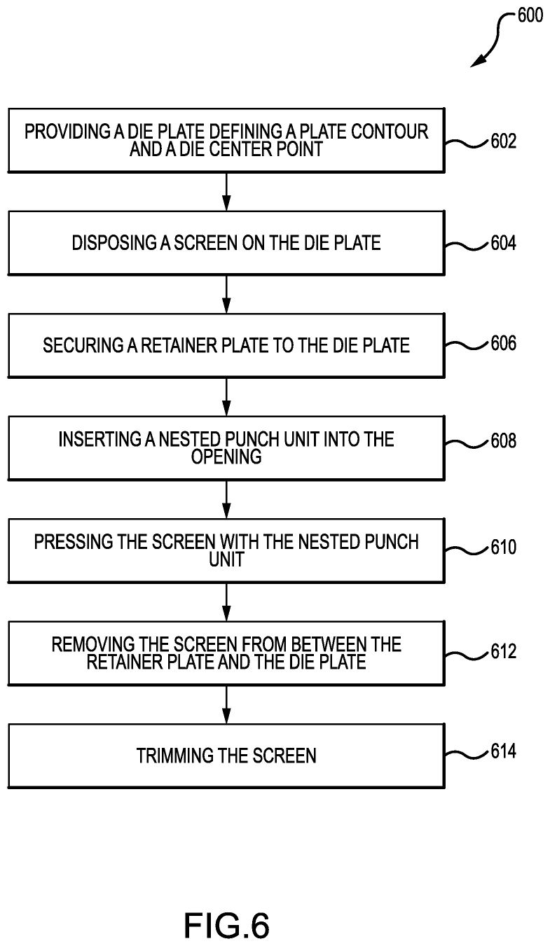

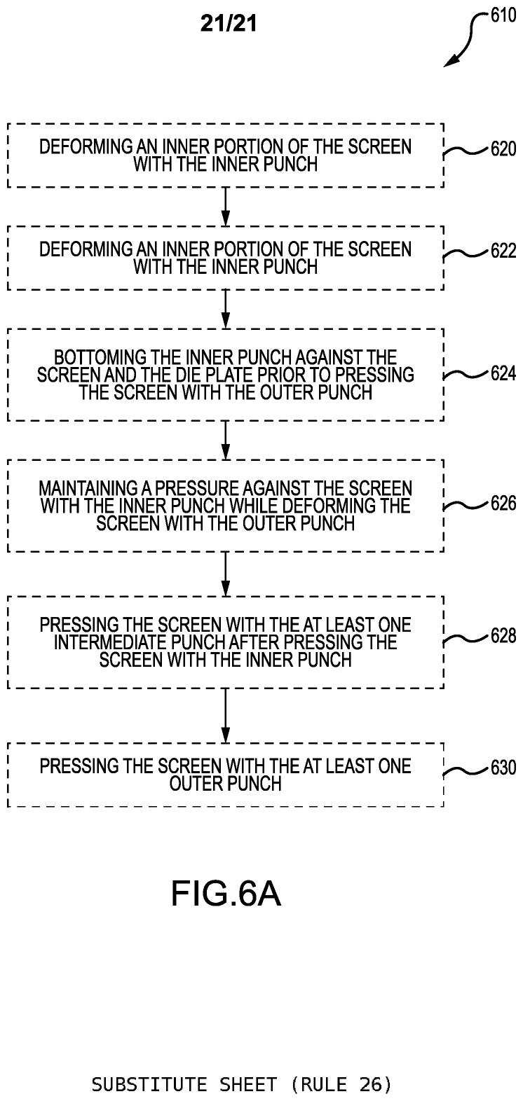

FIG. 6 depicts another method 600 of forming a forming mold screen. The method 600 begins with operation 602, providing a die plate defining a plate contour and a die center point. Examples of such die plates are depicted and described herein. In operation 604, disposing a screen on the die plate is performed. The screen is oversized, relative to an area of the die plate contour, so as to provide sufficient material to be fully deformed during the processes described herein. In its initial configuration, prior to any deformation processes being performed thereon, the screen substantially defines a plane. The method continues with operation 606, securing a retainer plate to the die plate. Examples of such retainer plates are described herein; in examples, the retainer plate defines an opening having a retainer center point substantially aligned with the die center point. Once the retainer plate is placed, the screen is disposed between the die plate and the retainer plate. At this point, the retainer plate may be secured to the die plate, as described herein. In operation 608, inserting a nested punch unit into the opening, is performed. A number of different configurations of nested punch units are depicted herein and would be apparent to a person of skill in the art. In one example, the nested punch unit at least includes an inner punch and an outer punch disposed around the inner punch. One or more intermediate punches located between the inner punch and outer punch may also be included. Regardless of the number of punches used, the punches may be aligned along an axis substantially aligned with the retainer center point.

In operation 610, pressing the screen with the nested punch unit, is performed. In examples, this operation includes pressing the screen with the inner punch followed by pressing the screen with the outer punch, which allows the screen to be deformed and edges thereof drawn inwards into the die plate, without marked separation or stretching of the mesh. Further operations relevant to operation 610 are described in the context of FIG. 6A. Staying with the description of FIG. 6, once the pressing operation 610 is finished, operation 612, removing the screen from between the retainer plate and the die plate, is performed. Thereafter, edges of the screen may be trimmed, operation 614.

FIG. 6A depicts optional operations related to the method 600 of FIG. 6. Namely, FIG. 6A depicts optional operations that many be performed during the pressing operation 610 described above in FIG. 6. One or more of these optional operations may be performed as part of the pressing operation 610. For example, operation 620 contemplates moving the inner punch towards the plate contour while substantially maintaining a position of the outer punch relative to the plate contour. In operation 622, deforming an inner portion of the screen with the inner punch, is performed. Such an operation may be followed by operation 624, bottoming the inner punch against the screen and the die plate prior to pressing the screen with the outer punch. In examples, pressing the screen with the nested punch unit may also include operation 626, maintaining a pressure against the screen with the inner punch while deforming the screen with the outer punch. Operations 624 and 626 helps prevent further deformation of the pressed, deformed portion of the screen, during any subsequent pressing operations with portions of the press location around the inner punch. In nested punches that include an intermediate punch, operation 628 may be performed after operation 622; that is, pressing the screen with the at least one intermediate punch. The bottoming operation and maintaining pressure operation described in the context of the inner punch may be also performed by any number of intermediate punches included in the nested punch. Deformation operations with any number of intermediate punches may be performed as needed, until operation 630, pressing the screen with at least one outer punch is performed. Deforming and bottoming operations may also be performed with the outer punch.

Notwithstanding that the numerical ranges and parameters setting forth the broad scope of the technology are approximations, the numerical values set forth in the specific examples are reported as precisely as possible. Any numerical value, however, inherently contain certain errors necessarily resulting from the standard deviation found in their respective testing measurements.

It will be clear that the systems and methods described herein are well adapted to attain the ends and advantages mentioned as well as those inherent therein. Those skilled in the art will recognize that the methods and systems within this specification may be implemented in many manners and as such are not to be limited by the foregoing exemplified embodiments and examples. In this regard, any number of the features of the different embodiments described herein may be combined into one single embodiment and alternate embodiments having fewer than or more than all of the features herein described are possible.

While various embodiments have been described for purposes of this disclosure, various changes and modifications may be made which are well within the scope contemplated by the present disclosure. Numerous other changes may be made which will readily suggest themselves to those skilled in the art and which are encompassed in the spirit of the disclosure.

What is claimed is:

1. A method of forming a forming mold screen, the method comprising:
providing a die plate defining a plate contour and a die center point;
disposing a screen on the die plate;
securing a retainer plate to the die plate, wherein the retainer plate defines an opening having a retainer center point substantially aligned with the die center point, and wherein the screen is disposed between the die plate and the retainer plate, and wherein the screen substantially defines a plane;
inserting a nested punch unit into the opening, wherein the nested punch unit comprises an inner punch and an outer punch disposed around the inner punch, and wherein the inner punch and the outer punch are aligned along an axis substantially aligned with the retainer center point; and
pressing the screen with the nested punch unit, wherein pressing the screen with the nested punch unit comprises pressing the screen with the inner punch followed by pressing the screen with the outer punch.

2. The method of claim 1, wherein the nested punch unit comprises at least one intermediate punch disposed between the inner punch and the outer punch, and wherein pressing the screen with the nested punch unit comprises pressing the screen with the at least one intermediate punch after pressing the screen with the inner punch and before pressing the screen with the outer punch.

3. The method of claim 1, wherein pressing the screen with the nested punch unit comprises moving the inner punch towards the plate contour while substantially maintaining a position of the outer punch relative to the plate contour.

4. The method of claim 1, wherein pressing the screen with the nested punch unit comprises deforming an inner portion of the screen with the inner punch.

5. The method of claim 4, wherein pressing the screen with the nested punch unit comprises maintaining a pressure against the screen with the inner punch while deforming the screen with the outer punch.

6. The method of claim 1, wherein pressing the screen with the nested punch unit comprises bottoming the inner punch against the screen and the die plate prior to pressing the screen with the outer punch.

7. The method of claim 6, wherein bottoming the inner punch substantially prevents further deformation of the screen by the inner punch.

8. The method of claim 1, wherein the nested punch unit comprises a pressing contour substantially similar to the plate contour.

9. The method of claim 6, wherein pressing the screen with the nested punch unit comprises bottoming the outer punch against the screen and die plate.

10. The method of claim 9, further comprising:
removing the screen from between the retainer plate and the die plate; and
trimming the screen.

11. A method of deforming a substantially flat screen, the method comprising:
disposing the substantially flat screen between a die plate comprising a contour and a retainer plate defining an opening having a retainer center point substantially aligned with a center point of the contour; and
sequentially deforming the screen with a plurality of punches, wherein the plurality of punches are substantially centered along an axis aligned with the center point of the contour, and wherein the plurality of punches comprise an inner punch and an outer punch and wherein the inner punch deforms the screen first and wherein the outer punch deforms the screen last.

12. The method of claim 11, further comprising, during the deformation of the screen by the outer punch, applying a pressure with the inner punch against the screen.

13. The method of claim 12, wherein the pressure applied against the screen by the inner punch is applied at least in part by a first spring.

14. The method of claim 13, wherein the first spring biases the inner punch away from the outer punch.

15. The method of claim 14, wherein the plurality of punches further comprise an intermediate punch between the inner punch and the outer punch, and wherein the intermediate punch deforms the screen after the inner punch and before the outer punch.

16. The method of claim 15, further comprising, during the deformation of the screen by the outer punch, applying pressure with the intermediate punch against the screen.

17. The method of claim 16, wherein the pressure applied against the screen by the intermediate punch is applied at least in part by a second spring.

18. The method of claim 17, wherein the second spring biases the intermediate punch away from the outer punch.

19. A system for deforming a screen, the system comprising:
a die plate defining a contour and a die center point;
a retainer plate defining an opening having a retainer center point substantially aligned with the die center point; and
a nested punch unit comprising an inner punch, an outer punch disposed around the inner punch, and a first spring biasing the inner punch away from the outer punch, wherein the inner punch and the outer punch are aligned along an axis substantially aligned with the retainer center point, wherein the nested punch unit comprises a deformation surface substantially mirrored to the contour.

20. The system of claim 19, wherein the inner punch is at least partially slidably engaged with the outer punch.

21. The system of claim 19, wherein the nested punch unit further comprises:
at least one intermediate punch disposed between the inner punch and the outer punch; and
a second spring biasing the intermediate punch away from the outer punch, and wherein the first spring biases the inner punch away from the intermediate punch.

22. The system of claim 21, wherein the inner punch is at least partially slidably received with the intermediate punch and the intermediate punch is at least partially slidably received in the outer punch.
